(19) United States
(12) Patent Application Publication
(10) Pub. No.: US 2016/0134708 A1
(43) Pub. Date: May 12, 2016

(54) SYSTEM AND METHOD FOR COOKIE MANAGEMENT

(71) Applicants: CHRISTIAN SUNDGAARD HANSEN, Copenhagen V (DK); Anders Haack Ibsen, Klampenborg (DK)

(72) Inventors: CHRISTIAN SUNDGAARD HANSEN, Copenhagen V (DK); Anders Haack Ibsen, Klampenborg (DK)

(21) Appl. No.: 14/934,633

(22) Filed: Nov. 6, 2015

Related U.S. Application Data
(60) Provisional application No. 62/076,625, filed on Nov. 7, 2014.

(51) Int. Cl. H04L 29/08

(52) U.S. Cl. CPC H04L 67/146; H04L 67/02; H04L 67/2814

(57) ABSTRACT

A method, computer program product, and computing system for, upon a user visiting a first website, determining if the user has ever visited the first website. If the user has never visited the first website, the user is automatically redirected to a second website. If the user has ever visited the second website is determined. If the user has already visited the second website, an existing unique identifier is obtained for the user. If the user has never visited the second website, a new unique identifier is generated for the user. The user is automatically redirected back to the first website in a manner that identifies the user.

### RELATED APPLICATION(S)

This application claims the benefit of U.S. Provisional Application Ser. No. 62/076,625, filed on 7 Nov. 2014, and entitled “MOBILE TARGETING SYSTEM AND METHOD”, the entire contents of which are herein incorporated by reference.

### TECHNICAL FIELD

This disclosure relates to cookie management and, more particularly, to third-party cookie management.

### BACKGROUND

Cookies are used to make browsing the internet more convenient and enjoyable. For example, when a user returns to a website and the website immediately knows who you are, that is because your information was stored during your earlier visit within a cookie on your local machine and that cookie was provided to the website upon your return visit.

There are different types of cookies, namely first party cookies and third party cookies. First party cookies are cookies that are stored on your local machine by a website that you actually visited; wherein third party cookies are cookies that are stored on your local machine by a website that you never visited.

Third party cookies may be provided by e.g., analytics companies that monitor your activity on the internet so that products/services may be recommended to you. Unfortunately, such third party cookies often raise security and/or privacy concerns so browsers are often configured to block the placement of such third party cookies on your local machine.

### SUMMARY OF DISCLOSURE

In one implementation, a computer-implemented method includes, upon a user visiting a first website, determining if the user has ever visited the first website. If the user has never visited the first website, the user is automatically redirected to a second website. If the user has ever visited the second website is determined. If the user has already visited the second website, an existing unique identifier is obtained for the user. If the user has never visited the second website, a new unique identifier is generated for the user. The user is automatically redirected back to the first website in a manner that identifies the user.

One or more of the following features may be included. Determining if the user has ever visited the first website may include determining if a cookie associated with the first website is present on a computer associated with the user. Automatically redirecting the user to a second website may include executing an HTTP 302 redirection to the second website. Determining if the user has ever visited the second website may include attempting to place a cookie associated with the second website onto a computer associated with the user. Automatically redirecting the user back to the first website may include generating a URL that locates the first website and includes at least one of the existing unique identifier and the new unique identifiers. Automatically redirecting the user back to the first website may include executing an HTTP 302 redirection to the first website. Upon the user being automatically redirected back to the first website, a cookie associated with the second website may be placed onto a computer associated with the user.

In another implementation, a computer program product resides on a computer readable medium that has a plurality of instructions stored on it. When executed by a processor, the instructions cause the processor to perform operations including, upon a user visiting a first website, determining if the user has ever visited the first website. If the user has never visited the first website, the user is automatically redirected to a second website. If the user has ever visited the second website is determined. If the user has already visited the second website, an existing unique identifier is obtained for the user. If the user has never visited the second website, a new unique identifier is generated for the user. The user is automatically redirected back to the first website in a manner that identifies the user.

One or more of the following features may be included. Determining if the user has ever visited the first website may include determining if a cookie associated with the first website is present on a computer associated with the user. Automatically redirecting the user to a second website may include executing an HTTP 302 redirection to the second website. Determining if the user has ever visited the second website may include attempting to place a cookie associated with the second website onto a computer associated with the user. Automatically redirecting the user back to the first website may include generating a URL that locates the first website and includes at least one of the existing unique identifier and the new unique identifiers. Automatically redirecting the user back to the first website may include executing an HTTP 302 redirection to the first website. Upon the user being automatically redirected back to the first website, a cookie associated with the second website may be placed onto a computer associated with the user.

In another implementation, a computing system includes at least one processor and at least one memory architecture coupled with the at least one processor, wherein the computing system is configured to perform operations including , upon a user visiting a first website, determining if the user has ever visited the first website. If the user has never visited the first website, the user is automatically redirected to a second website. If the user has ever visited the second website is determined. If the user has already visited the second website, an existing unique identifier is obtained for the user. If the user has never visited the second website, a new unique identifier is generated for the user. The user is automatically redirected back to the first website in a manner that identifies the user.

One or more of the following features may be included. Determining if the user has ever visited the first website may include determining if a cookie associated with the first website is present on a computer associated with the user. Automatically redirecting the user to a second website may include executing an HTTP 302 redirection to the second website. Determining if the user has ever visited the second website may include attempting to place a cookie associated with the second website onto a computer associated with the user. Automatically redirecting the user back to the first website may include generating a URL that locates the first website and includes at least one of the existing unique identifier and the new unique identifiers. Automatically redirecting the user back to the first website may include executing an HTTP 302 redirection to the first website. Upon the user being automatically redirected back to the first website, a cookie associated with the second website may be placed onto a computer associated with the user.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a cookie management process coupled to a distributed computing network; and

FIG. 2 is a flow chart of the cookie management process of FIG. 1.

Like reference symbols in the various drawings indicate like elements.

### DETAILED DESCRIPTION OF THE PREFERRED EMBODIMENTS

### System Overview:

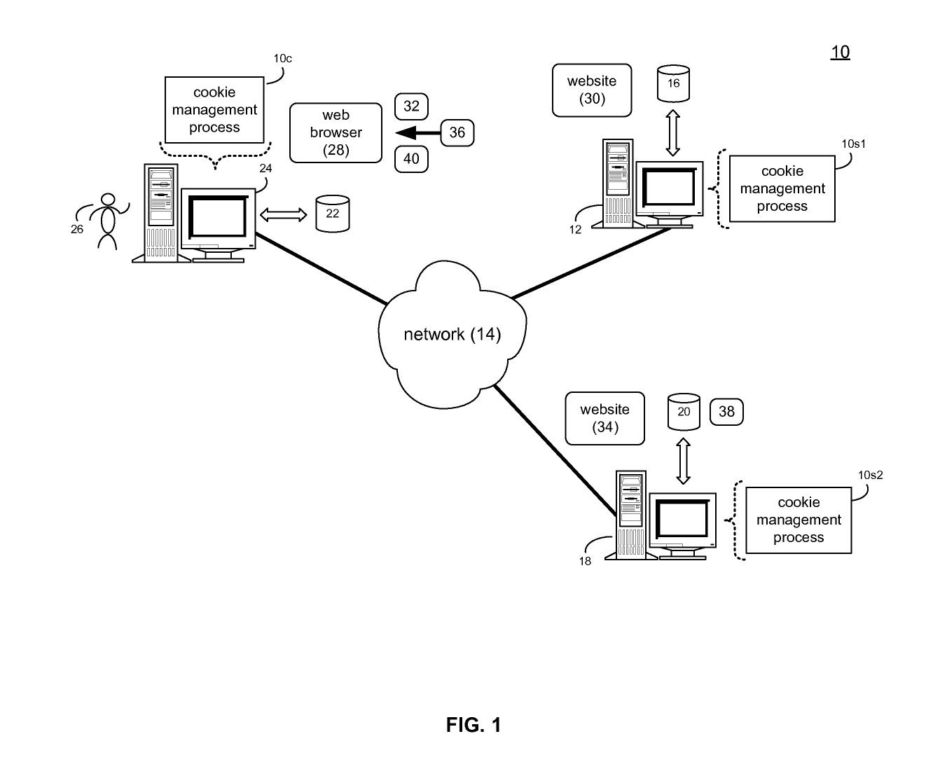

Referring to FIG. 1, there is shown cookie management process 10. As will be discussed below in greater detail, cookie management process 10 may be configured to manage the generation and deployment of cookies on devices coupled via a network (e.g., the internet).

Cookie management process 10 may be implemented as a server-side process, a client-side process, or a hybrid server-side/client-side process. For example, cookie management process 10 may be implemented as a purely server-side process via cookie management process 10s1 and/or cookie management process 10s2. Alternatively, cookie management process 10 may be implemented as a purely client-side process via cookie management process 10c. Alternatively still, cookie management process 10 may be implemented as a hybrid server-side/client-side process via cookie management process 10s1 and/or cookie management process 10s2 in combination with cookie management process 10c. Accordingly, cookie management process 10 as used in this disclosure may include any combination of cookie management process 10s and cookie management process 10c.

Cookie management process 10s1 may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device. Computing device 12 may execute an operating system, examples of which may include but are not limited to Microsoft Windows™, MacOS™, Android™, WebOS™, iOS™, Redhat Linux™, or a custom operating system.

The instruction sets and subroutines of cookie management process 10s1, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices. Any data generated, in whole or in part, by cookie management process 10s1 may be stored on storage device 16 coupled to computing device 12.

Cookie management process 10s2 may be a server application and may reside on and may be executed by computing device 18, which may be connected to network 14 (e.g., the Internet or a local area network). Examples of computing device 18 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device. Computing device 18 may execute an operating system, examples of which may include but are not limited to Microsoft Windows™, MacOS™, Android™, WebOS™, iOS™, Redhat Linux™, or a custom operating system.

The instruction sets and subroutines of cookie management process 10s2, which may be stored on storage device 20 coupled to computing device 18, may be executed by one or more processors (not shown) and one or more memory architectures (not shown) included within computing device 18. Examples of storage device 20 may include but are not limited to: a hard disk drive; a tape drive; an optical drive; a RAID device; a random access memory (RAM); a read-only memory (ROM); and all forms of flash memory storage devices. Any data generated, in whole or in part, by cookie management process 10s2 may be stored on storage device 20 coupled to computing device 18.

Either of cookie management process 10s1 or cookie management process 10s2 may be an applet or portion of code that is configured to work with the other cookie management process. For example, cookie management process 10s1 may be a portion of code that interacts with/works in conjunction with cookie management process 10s2.

Examples of cookie management process 10c may include but are not limited to a web browser (or portion thereof), a specialized desktop application, a game console user interface, or a specialized handheld application (e.g., an application running on e.g., the Android™ platform or the iPhone™ platform). The instruction sets and subroutines of cookie management process 10c, which may be stored on storage devices 22 coupled to client electronic device 24, may be executed by one or more processors (not shown) and one or more memory architectures (not shown) incorporated into client electronic device 24. Examples of storage device 22 may include but are not limited to: hard disk drives; tape drives; optical drives; RAID devices; random access memories (RAM); read-only memories (ROM), and all forms of flash memory storage devices. Any data generated, in whole or in part, by cookie management process 10c may be stored on storage device 22 coupled to client electronic device 24.

Examples of client electronic device 24 may include, but are not limited to personal computer 24, a smartphone (not shown), a laptop computer (not shown), a personal digital assistant (not shown), a tablet computer (not shown), a notebook computer (not shown), a server computer (not shown), a gaming console (not shown), a smart television (not shown), and a dedicated network device (not shown). Client electronic device 24 may execute an operating system, examples of which may include but are not limited to Microsoft Windows™, MacOS™, Android™, WebOS™, iOS™, Redhat Linux™, or a custom operating system.

### Cookie Management Process:

As discussed above, cookie management process 10 may be configured to manage the generation and deployment of cookies on devices coupled via a network (e.g., the internet). Examples of such cookies may include first party cookies (i.e., cookies that are stored on your local machine by a website that you actually visited) and third party cookies (i.e., cookies that are stored on your local machine by a website that you never visited).

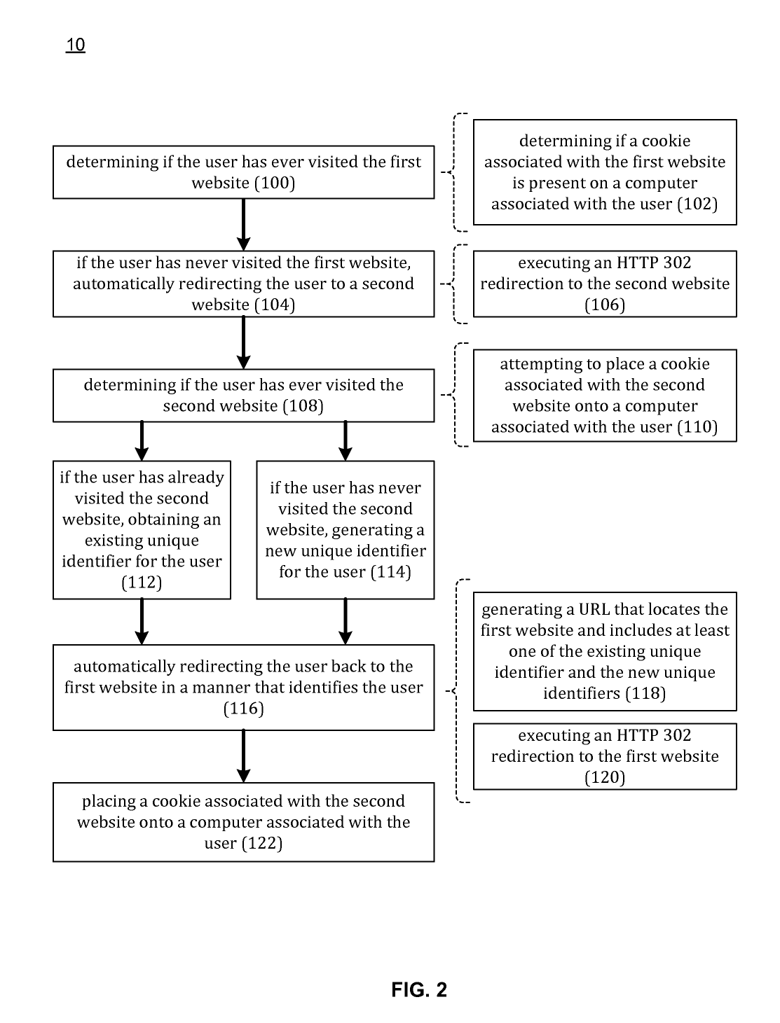

Referring also to FIG. 2, assume for illustrative purposes that user 26 is using web browser 28 (executed on client electronic device 24) to browse various websites, examples of which may include but are not limited to first website 30. Upon user 26 visiting first website 30, cookie management process 10 may determine 100 if user 26 has ever visited first website 30. For example and for illustrative purposes only, when determining 100 if user 26 has ever visited first website 30, cookie management process 10 may determine 102 if a cookie associated with first website 28 is present on a computer (e.g., client electronic device 24) associated with user 26.

As discussed above, cookies (e.g., cookie 32) are used to make browsing the internet more convenient and enjoyable. For example, when a user (e.g., user 26) returns to a website (e.g., website 30) and that website immediately knows who user 26 is, that is because information concerning user 26 was stored within e.g., cookie 32 during an earlier visit of user 26 to website 30; wherein cookie 32 may be stored on (in this example) client electronic device 24, may be available to web browser 28, and may be provided to website 30 upon the return of user 26 to website 30.

Accordingly, when determining 100 if user 26 has ever visited first website 30, cookie management process 10 may determine 102 if any of the cookies (e.g., cookie 32) available to and/or utilized by web browser 28 are associated with first website 30. If (in this example) cookie 32 is associated with first website 30, user 26 has previously visited first website 30 and, therefore, cookie management process 10 may take no action.

Assume for the following example that only one cookie (e.g., cookie 32) is available to and/or utilized by web browser 28 and that cookie 32 is not associated with website 30. Therefore, user 26 has not previously visited first website 30. Since user 26 has never visited first website 30, cookie management process 10 may automatically redirect 104 user 26 to second website 34. When automatically redirecting 104 user 26 to second website 34, cookie management process 10 may execute 106 an HTTP 302 redirection to second website 34. As is known in the art, an HTTP 302 redirection is a command to redirect to another location (e.g., another URL) on the premise that the URL that you are seeking (e.g., the URL of website 30) is temporarily unavailable.

Upon user 26 being automatically redirected 104 to second website 34, cookie management process 10 may determine 108 if user 26 has ever visited second website 34.

When determining 108 if user 26 has ever visited second website 34, cookie management process 10 may determine if any of the cookies (e.g., cookie 32) available to and/or utilized by web browser 28 are associated with second website 34. If (in this example) only one cookie (e.g., cookie 32) is available to and/or utilized by web browser 28 and cookie 32 is not associated with second website 34, user 26 has not previously visited second website 34. Conversely, if cookie 32 is associated with second website 34, user 26 has previously visited second website 34.

Additionally/alternatively, when determining 108 if user 26 has ever visited second website 34, cookie management process 10 may attempt 110 to place a cookie (e.g., cookie 36) that is associated with second website 34 onto the computer associated with user 26 (namely client electronic device 24). If cookie management process 10 cannot place cookie 36 (associated with second website 34) onto client electronic device 24, user 26 has not previously visited second website 34 (as e.g., web browser 28 blocking the writing of cookie 36 to client electronic device 24 indicates that cookie 36 is a third-party cookie). Conversely, if cookie management process 10 can place cookie 36 (associated with second website 34) onto client electronic device 24, user 26 has previously visited second website 34 (as e.g., web browser 28 allowing the writing of cookie 36 to client electronic device 24 indicates that cookie 36 is not a third-party cookie).

If cookie management process 10 determines 108 that user 26 has already visited second website 34 (e.g., a cookie associated with website 34 was found on client electronic device 24 and/or web browser 28 allowed the writing of cookie 36 to client electronic device 24), cookie management process 10 may obtain 112 an existing unique identifier for user 26. For example, cookie 32 may contain information (i.e., an existing unique identifier) that identifies user 26 and is obtainable 112 by cookie management process 10. Examples of such an existing unique identifier may include but are not limited to identifiers that are based upon and/or include (in whole or in part): a number for user 26, an alphanumeric code for user 26, an account identifier for user 26, a social security number for user 26, an address for user 26, a telephone number for user 26, an email address for user 26, a shopping cart for user 26, product preferences for user 26, and service preferences for user 26).

If cookie management process 10 determines 108 that user 26 has never visited second website 34 (e.g., a cookie associated with website 34 was not found on client electronic device 24 and/or web browser 28 blocked the writing of cookie 36 to client electronic device 24), cookie management process 10 may generate 114 a new unique identifier for user 26. Examples of such a new unique identifier may include but are not limited to identifiers that are based upon and/or include (in whole or in part): a number for user 26, an alphanumeric code for user 26, an account identifier for user 26, a social security number for user 26, an address for user 26, a telephone number for user 26, an email address for user 26, a shopping cart for user 26, product preferences for user 26, and service preferences for user 26).

Cookie management process 10 may store this unique identifier for (in this example) user 26 on computing device 18 (i.e., the computing device associated with website 34) so that it may be available for later use by cookie management process 10, wherein this unique identifier may be included/encapsulated within a cookie (e.g., cookie 38) that may be stored on storage device 20 coupled to computing device 18.

Once a unique identifier is obtained 112 for (or generated 114 for) e.g., user 26, cookie management process 10 may automatically redirect 116 user 26 back to first website 30 in a manner that identifies user 26. When automatically redirecting 116 user 26 back to first website 30, cookie management process 10 may generate 118 a URL that locates first website 30 and includes the unique identifier (be it the existing unique identifier obtained 112 by cookie management process 10 or the new unique identifier generated 114 by cookie management process 10).

For example, cookie management process 10 may generate 118 a URL specific to user 26 that not only identifies the locations of first website 30 but also the identity of user 26 via the above-described unique identifier, wherein examples of such a unique identifier may include but are not limited to identifiers that are based upon and/or include (in whole or in part): a number for user 26, an alphanumeric code for user 26, an account identifier for user 26, a social security number for user 26, an address for user 26, a telephone number for user 26, an email address for user 26, a shopping cart for user 26, product preferences for user 26, and service preferences for user 26).

When automatically redirecting 116 user 26 back to first website 30, cookie management process 10 may execute 120 an HTTP 302 redirection to first website 30. As discussed above, an HTTP 302 redirection is a command to redirect to another location (e.g., another URL) on the premise that the URL that you are seeking (e.g., the URL of website 34) is temporarily unavailable.

Upon user 26 being automatically redirected 116 back to first website 30, cookie management process 10 may place 122 a cookie (e.g., cookie 40) associated with second website 34 onto a computer associated with user 26 (e.g., client electronic device 24). Specifically and through the use of two automatic redirections (i.e., redirection 104 to second website 34 and redirection 116 from second website 34), cookie 40 may be placed upon client electronic device 24 since cookie 40 is not a third-party cookie being that user 26 visited second website 34.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
upon a user visiting a first website, determining if the user has ever visited the first website;
if the user has never visited the first website, automatically redirecting the user to a second website;
determining if the user has ever visited the second website:
if the user has already visited the second website, obtaining an existing unique identifier for the user, and
if the user has never visited the second website, generating a new unique identifier for the user; and
automatically redirecting the user back to the first website in a manner that identifies the user.

2. The computer-implemented method of claim 1 wherein determining if the user has ever visited the first website includes:
determining if a cookie associated with the first website is present on a computer associated with the user.

3. The computer-implemented method of claim 1 wherein automatically redirecting the user to a second website includes:
executing an HTTP 302 redirection to the second website.

4. The computer-implemented method of claim 1 wherein determining if the user has ever visited the second website includes:
attempting to place a cookie associated with the second website onto a computer associated with the user.

5. The computer-implemented method of claim 1 wherein automatically redirecting the user back to the first website includes:
generating a URL that locates the first website and includes at least one of the existing unique identifier and the new unique identifiers.

6. The computer-implemented method of claim 1 wherein automatically redirecting the user back to the first website includes:
executing an HTTP 302 redirection to the first website.

7. The computer-implemented method of claim 1 further comprising:
upon the user being automatically redirected back to the first website, placing a cookie associated with the second website onto a computer associated with the user.

8. A computer program product residing on a computer readable medium having a plurality of instructions stored thereon which, when executed by a processor, cause the processor to perform operations comprising:
upon a user visiting a first website, determining if the user has ever visited the first website;
if the user has never visited the first website, automatically redirecting the user to a second website;
determining if the user has ever visited the second website:
if the user has already visited the second website, obtaining an existing unique identifier for the user, and
if the user has never visited the second website, generating a new unique identifier for the user; and
automatically redirecting the user back to the first website in a manner that identifies the user.

9. The computer program product of claim 8 wherein determining if the user has ever visited the first website includes:
determining if a cookie associated with the first website is present on a computer associated with the user.

10. The computer program product of claim 8 wherein automatically redirecting the user to a second website includes:
executing an HTTP 302 redirection to the second website.

11. The computer program product of claim 8 wherein determining if the user has ever visited the second website includes:
attempting to place a cookie associated with the second website onto a computer associated with the user.

12. The computer program product of claim 8 wherein automatically redirecting the user back to the first website includes:
generating a URL that locates the first website and includes at least one of the existing unique identifier and the new unique identifiers.

13. The computer program product of claim 8 wherein automatically redirecting the user back to the first website includes:
executing an HTTP 302 redirection to the first website.

14. The computer program product of claim 8 further comprising instructions for:
upon the user being automatically redirected back to the first website, placing a cookie associated with the second website onto a computer associated with the user.

15. A computing system including a processor and memory configured to perform operations comprising:
upon a user visiting a first website, determining if the user has ever visited the first website;
if the user has never visited the first website, automatically redirecting the user to a second website;
determining if the user has ever visited the second website:
if the user has already visited the second website, obtaining an existing unique identifier for the user, and
if the user has never visited the second website, generating a new unique identifier for the user; and
automatically redirecting the user back to the first website in a manner that identifies the user.

16. The computing system of claim 15 wherein determining if the user has ever visited the first website includes:
determining if a cookie associated with the first website is present on a computer associated with the user.

17. The computing system of claim 15 wherein automatically redirecting the user to a second website includes:
executing an HTTP 302 redirection to the second website.

18. The computing system of claim 15 wherein determining if the user has ever visited the second website includes:
attempting to place a cookie associated with the second website onto a computer associated with the user.

19. The computing system of claim 15 wherein automatically redirecting the user back to the first website includes:
generating a URL that locates the first website and includes at least one of the existing unique identifier and the new unique identifiers.

20. The computing system of claim 15 wherein automatically redirecting the user back to the first website includes:
executing an HTTP 302 redirection to the first website.

21. The computing system of claim 15 further configured to perform operations comprising:
upon the user being automatically redirected back to the first website, placing a cookie associated with the second website onto a computer associated with the user.
